(19) United States
(12) Patent Application Publication
(10) Pub. No.: US 2020/0109794 A1
(43) Pub. Date: Apr. 9, 2020

(54) TOUCH-SENSITIVE FAUCET AND METHOD FOR CONTROLLING SAME

(71) Applicant: XIAMEN OLT CO., LTD.

(72) Inventor: Duanlong WU, Fujian (CN)

(21) Appl. No.: 16/486,402

(22) PCT Filed: Feb. 27, 2018
(86) PCT No.: PCT/CN2018/077323

§ 371 Date: Aug. 15, 2019

(30) Foreign Application Priority Data
Dec. 29, 2017 (CN) 201711485848.8

(51) Int. Cl. F16K 31/60; F16K 31/05; E03C 1/23

(52) U.S. Cl. CPC F16K 31/605; E03C 2001/2311; E03C 1/2302; F16K 31/055

(57) ABSTRACT

The invention provides a touch-sensitive faucet, wherein a cold water intake end and a hot water intake end of a water mixing valve herein are respectively connected to a cold water intake pipe and a hot water intake pipe; and non-return valves are respectively provided between the cold water intake pipe and the water mixing valve and between the hot water intake pipe and the water mixing valve, preventing back flow due to pressure difference between cold water and hot water. The touch-sensitive faucet uses an operating method of outputting water after touch is removed, which can prevent waste of water resources caused by erroneous water output during operation and provide better user experience, compared with directly outputting water by touch.

### FIELD OF THE INVENTION

The invention relates to the field of faucets, and particularly to a touch-sensitive faucet and a method for controlling same.

### BACKGROUND OF THE INVENTION

As necessary devices for daily production and life, faucets are widely used in places such as kitchens and bathrooms. Early faucets were mainly turned on and off by manual switches. With the development of technology, water is turned on and off by a touch-sensitive mode. Such sensitive mode requires the use of a solenoid valve to control, but when the solenoid valve is damaged or powered off, faucets cannot be used. To solve this problem, there is a kitchen faucet that combines a sensitive mode with a manual switch, wherein the switching between the sensitive mode and the manual switch is achieved by a switching valve body, but this requires an additional regulating valve to achieve the function of the manual switch, resulting in a complicated structure and higher cost. In addition, the existing touch-sensitive faucets are basically turned on and off by touching faucet bodies for a predetermined time, but in practical use, if a user needs to turn the faucet and just touches the faucet and if an electrically charged object contacts the faucet, water will be directly discharged, resulting in waste of water resources.

### SUMMARY OF THE INVENTION

A technical problem to be solved by the invention is to provide a touch-sensitive faucet and a method for controlling same so as to solve the problems in the background art.

The technical problem to be solved by the invention is achieved by the following technical solution: a touch-sensitive faucet comprises a faucet body, a spray head, a water mixing valve and a master control box, wherein the spray head is provided at an upper end of the faucet body, and the water mixing valve is provided in a lower end of the faucet body; a cold water intake end and a hot water intake end of the water mixing valve are respectively connected to a cold water intake pipe and a hot water intake pipe; non-return valves are respectively provided between the cold water intake pipe and the water mixing valve and between the hot water intake pipe and the water mixing valve, preventing back flow due to pressure difference between cold water and hot water; a water output end of the water mixing valve is connected to a water intake end of the master control box; a handle of the water mixing valve extends out of the faucet body, the water mixing valve can regulate temperature by turning the handle, and water can be turned on or off by pressing or lifting the handle; the master control box comprises a knob, a water intake end, a water output end and a motor valve assembly; when the knob is in a first position, in a valve opening state, the motor valve assembly is in a pressure relief state, the water intake end and the water output end of the master control box are on, and water is outputted from the faucet, while in a valve closing state, the motor valve assembly is in a pressure maintaining state, the water intake end and the water output end of the master control box are off, and the faucet is turned off; and the motor valve assembly is provided with a driven gear and a limiting step, the driven gear is provided with a boss, and when the knob is in a second position after being turned by 180 degrees, a swing arm on the knob and the limiting step fix the driven gear at the second position, the motor valve assembly is in a manual state and is not controlled by a motor, i.e. the water intake end and the water output end of the master control box are in a on state, and turning water on and off is manually controlled by the handle.

Further, the water output end of the master control box is communicated with the spray head, the motor valve assembly and a touch control assembly are respectively electrically connected to a control circuit board, the touch control assembly is connected to the faucet body via a signal line, and the faucet body is made of a conductive material and is fixedly mounted on a table by an insulating base such as a plastic base so as to be insulated from the table; and the control circuit board is connected to a battery via a power line and supplied with power by the battery.

Further, the water output end of the water mixing valve is connected to the water intake end of the master control box through a first hose, the water output end of the master control box is communicated with the spray head through a second hose, the spray head is withdrawably provided at an upper end of the faucet body, the second hose is provided with a gravity block to reset the spray head, the spray head is insulated from the faucet body by an insulating member, a magnetic switch is arranged at a connection between the spray head and the faucet body, and the magnetic switch is electrically connected to the control circuit board.

Further, the spray head is provided with a spray changeover switch, and the water stream shape of the spray head can be changed by pressing the spray changeover switch.

Further, the faucet body is made of a conductive material; the touch control assembly functions to control in a mode of triggering upon removal of a sensing body, i.e. the faucet is not turned on and off when the human body contacts the faucet body, but when touch is removed; the control circuit board is connected to a power source via a power line; and non-return valves are respectively provided between the cold water intake pipe and the water mixing valve and between the hot water intake pipe and the water mixing valve.

Further, the cold water intake end and the hot water intake end are provided with control valves for controlling cold water intake and hot water intake respectively, and the faucet body transmits a touch signal to a master controller to notify turning on or off cold water and hot water.

A method for controlling the touch-sensitive faucet comprises:

turning the switching knob to the first position, lifting the handle to open the water mixing valve and turning the handle to regulate the water output temperature, then withdrawing the spray head to output water and resetting the spray head to turn off water;
turning the switching knob to the first position, lifting the handle to open the water mixing valve and turning the handle to regulate the water output temperature, then touching the faucet body to output water, and touching the faucet body again to turn off water, or turning off water without touching the faucet body after a period of time; and
turning the switching knob to the second position, turning on or off water by lifting or pressing the handle and regulating the water output temperature by turning the handle.

Compared with the prior art, the invention has the following advantages: the touch-sensitive faucet of the invention has diversified functions of outputting water by withdrawal, touch and a manual switch, has a simple structure, only needs a single water path to enable free switching between the double functions of manual water output and sensitive water output, and can complete the switching through just turning the knob by 180 degrees, which is flexible and simple to operate; and the touch-sensitive faucet uses an operating method of outputting water after touch is removed, which can prevent waste of water resources caused by erroneous water output during operation and provide better user experience, compared with directly outputting water by touch.

### BRIEF DESCRIPTION OF THE DRAWINGS

FIG. 1 is a schematic structural view of the invention;

FIG. 2 is a schematic structural view showing valve opening by a master control box of the invention;

FIG. 3 is a schematic structural view showing valve closing by the master control box of the invention;

FIG. 4 is a schematic structural view showing manual valve opening in the invention; and

FIG. 5 is a schematic structural view showing manual valve closing in the invention.

### DETAILED DESCRIPTION OF THE INVENTION

In order that the technical means, inventive features and workflow of the invention as well as the objects and efficacies achieved by the method of the invention are readily understood, the technical solutions in the embodiments of the invention will be clearly and completely described below in conjunction with the embodiments of the invention. It is apparent that the described embodiments are only part of rather than all of the embodiments in the invention. Based on the embodiments of the invention, all other embodiments obtained by the ordinary persons skilled in the art without inventive work belong to the protection scope of the invention.

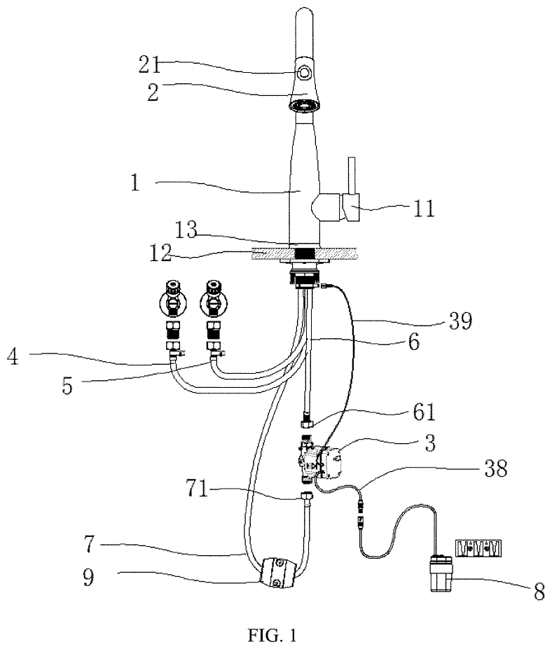

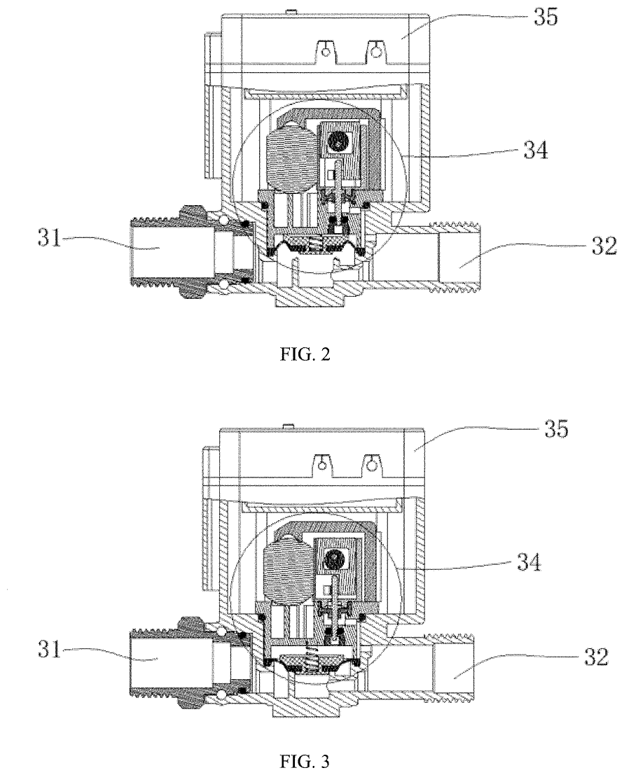

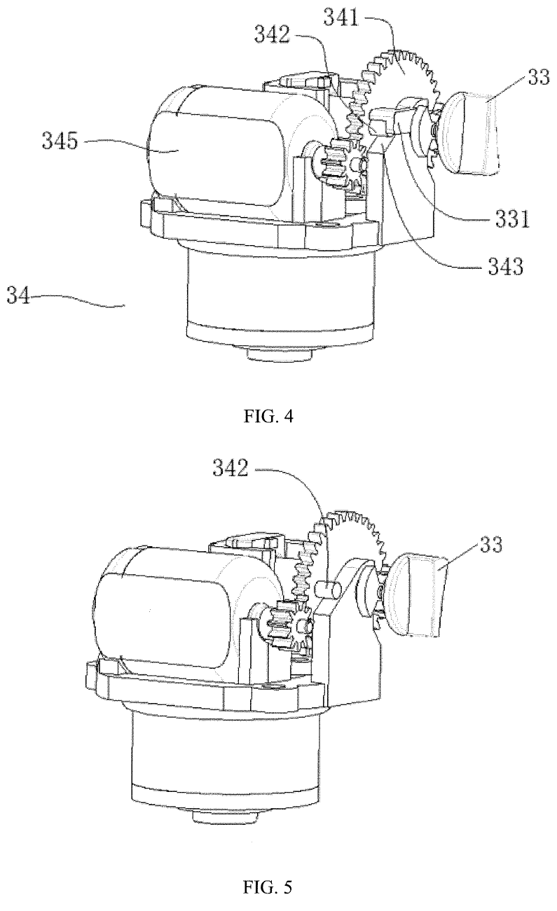

As shown in FIGS. 1 to 5, a touch-sensitive faucet comprises a faucet body 1, a spray head 2, a water mixing valve (not shown) and a master control box 3, wherein the spray head 2 is provided at an upper end of the faucet body 1, and the water mixing valve is provided in a lower end of the faucet body 1; a cold water intake end and a hot water intake end of the water mixing valve are respectively connected to a cold water intake pipe 4 and a hot water intake pipe 5; in the particular embodiment, non-return valves are respectively provided between the cold water intake pipe 4 and the water mixing valve and between the hot water intake pipe 5 and the water mixing valve, preventing back flow due to pressure difference between cold water and hot water; a water output end of the water mixing valve is connected to a water intake end 31 of the master control box 3; a handle 11 of the water mixing valve extends out of the faucet body 1, the water mixing valve can regulate temperature by turning the handle 11, and water can be turned on or off by pressing or lifting the handle 11; the master control box 3 comprises a knob 33, a water intake end 31, a water output end 32 and a motor valve assembly 34; when the knob 33 is in a first position, in a valve opening state, the motor valve assembly 34 is in a pressure relief state, the water intake end 31 and the water output end 32 of the master control box 3 are on, and water is outputted from the faucet, while in a valve closing state, the motor valve assembly 34 is in a pressure maintaining state, the water intake end 31 and the water output end 32 of the master control box 3 are off, and the faucet is turned off; and the motor valve assembly 34 is provided with a driven gear 341 and a limiting step 343, the driven gear 341 is provided with a boss 342, and when the knob 33 is in a second position after being turned by 180 degrees, a swing arm 331 on the knob 33 and the limiting step 343 fix the driven gear at the second position, the motor valve assembly 34 is in a manual state and is not controlled by a motor 345. That is, the water intake end and the water output end of the master control box are in a on state, and turning water on and off is manually controlled by the handle 11.

Specifically, the water output end 32 of the master control box 3 is communicated with the spray head 2, the motor valve assembly 34 and a touch control assembly are respectively electrically connected to a control circuit board, the touch control assembly is connected to the faucet body 1 via a signal line 39, and the faucet body 1 is made of a conductive material and is fixedly mounted on a table 12 by an insulating base 13 such as a plastic base so as to be insulated from the table 12. The control circuit board is connected to a battery 8 via a power line 38 and supplied with power by the battery 8. Of course, in other embodiments, the control circuit board can also be connected to the mains by a power adapter and supplied with power by the mains.

Specifically, the water output end of the water mixing valve is connected to the water intake end 31 of the master control box 3 through a first hose 6, the water output end 32 of the master control box 3 is communicated with the spray head 2 through a second hose 7, the spray head 2 is withdrawably provided at an upper end of the faucet body 1, the second hose 7 is provided with a gravity block 9 to reset the spray head 2, the spray head 2 is insulated from the faucet body 1 by an insulating member, a magnetic switch is arranged at a connection between the spray head 2 and the faucet body 1, and the magnetic switch is electrically connected to the control circuit board. Specifically, the spray head 2 is provided with a spray changeover switch 21, and the water stream shape of the spray head can be changed by pressing the spray changeover switch 21.

Specifically, the faucet body is made of a conductive material; the touch control assembly functions to control in a mode of triggering upon removal of a sensing body, i.e. the faucet is not turned on and off when the human body contacts the faucet body, but when touch is removed; the control circuit board is connected to a power source via a power line; and non-return valves are respectively provided between the cold water intake pipe and the water mixing valve and between the hot water intake pipe and the water mixing valve.

Specifically, the cold water intake end and the hot water intake end are provided with control valves for controlling cold water intake and hot water intake respectively, and the faucet body transmits a touch signal to a master controller to notify turning on or off cold water and hot water.

A method for controlling the touch-sensitive faucet comprises:

turning the switching knob 33 to the first position, lifting the handle 11 to open the water mixing valve and turning the handle 11 to regulate the water output temperature, then withdrawing the spray head 2 to output water and resetting the spray head 2 to turn off water;
turning the switching knob 33 to the first position, lifting the handle 11 to open the water mixing valve and turning the handle 11 to regulate the water output temperature, then touching the faucet body 1 to output water, and touching the faucet body 1 again to turn off water, or turning off water without touching the faucet body 1 after a period of time; and
turning the switching knob 33 to the second position, turning on or off water by lifting or pressing the handle 11 and regulating the water output temperature by turning the handle 11.

The basic principles, main features and advantages of the invention have been illustrated and described above. Those skilled in the art should understand that the invention is not limited to the above embodiments, merely the principles of the invention are described in the above embodiments and the description, various changes and improvements can also be made to the invention without departing from the spirit and scope of the invention, and these changes and improvements shall fall within the claimed scope of the invention. The claimed scope of the invention is defined by the appended claims and equivalents thereof.

1. A touch-sensitive faucet, comprising a faucet body, a spray head, a water mixing valve and a master control box, the spray head being provided at an upper end of the faucet body, and the water mixing valve being provided in a lower end of the faucet body; a cold water intake end and a hot water intake end of the water mixing valve being respectively connected to a cold water intake pipe and a hot water intake pipe; non-return valves being respectively provided between the cold water intake pipe and the water mixing valve and between the hot water intake pipe and the water mixing valve, preventing back flow due to pressure difference between cold water and hot water; a water output end of the water mixing valve being connected to a water intake end of the master control box; and a handle of the water mixing valve extending out of the faucet body, the water mixing valve being capable of regulating temperature by turning the handle, and water being capable of being turned on or off by pressing or lifting the handle; wherein the master control box comprises a knob, a water intake end, a water output end and a motor valve assembly; when the knob is in a first position, in a valve opening state, the motor valve assembly is in a pressure relief state, the water intake end and the water output end of the master control box are on, and water is outputted from the faucet, while in a valve closing state, the motor valve assembly is in a pressure maintaining state, the water intake end and the water output end of the master control box are off, and the faucet is turned off; and the motor valve assembly is provided with a driven gear and a limiting step, the driven gear is provided with a boss, and when the knob is in a second position after being turned by 180 degrees, a swing arm on the knob and the limiting step fix the driven gear at the second position, the motor valve assembly is in a manual state and is not controlled by a motor, i.e. the water intake end and the water output end of the master control box are in a on state, and turning water on and off is manually controlled by the handle.

2. The touch-sensitive faucet according to claim 1, wherein the water output end of the master control box is communicated with the spray head, the motor valve assembly and a touch control assembly are respectively electrically connected to a control circuit board, the touch control assembly is connected to the faucet body via a signal line, and the faucet body 1 is made of a conductive material and is fixedly mounted on a table by an insulating base such as a plastic base so as to be insulated from the table; and the control circuit board is connected to a battery via a power line and supplied with power by the battery.

3. The touch-sensitive faucet according to claim 2, wherein the water output end of the water mixing valve is connected to the water intake end of the master control box through a first hose, the water output end of the master control box is communicated with the spray head through a second hose, the spray head is withdrawably provided at an upper end of the faucet body, the second hose is provided with a gravity block to reset the spray head, the spray head is insulated from the faucet body by an insulating member, a magnetic switch is arranged at a connection between the spray head and the faucet body, and the magnetic switch is electrically connected to the control circuit board.

4. The touch-sensitive faucet according to claim 1, wherein the spray head is provided with a spray changeover switch, and the water stream shape of the spray head can be changed by pressing the spray changeover switch.

5. The touch-sensitive faucet according to claim 1, wherein the faucet body is made of a conductive material; the touch control assembly functions to control in a mode of triggering upon removal of a sensing body, i.e. the faucet is not turned on and off when the human body contacts the faucet body, but when touch is removed; the control circuit board is connected to a power source via a power line; and non-return valves are respectively provided between the cold water intake pipe and the water mixing valve and between the hot water intake pipe and the water mixing valve.

6. The touch-sensitive faucet according to claim 1, wherein the cold water intake end and the hot water intake end are provided with control valves for controlling cold water intake and hot water intake respectively, and the faucet body transmits a touch signal to a master controller to notify turning on or off cold water and hot water.

7. A method for controlling the touch-sensitive faucet, comprising:
turning the switching knob to the first position, lifting the handle to open the water mixing valve and turning the handle to regulate the water output temperature, then withdrawing the spray head to output water and resetting the spray head to turn off water;
turning the switching knob to the first position, lifting the handle to open the water mixing valve and turning the handle to regulate the water output temperature, then touching the faucet body to output water, and touching the faucet body again to turn off water, or turning off water without touching the faucet body after a period of time; and
turning the switching knob to the second position, turning on or off water by lifting or pressing the handle and regulating the water output temperature by turning the handle.
